(19) United States
(12) Patent Application Publication
(10) Pub. No.: US 2023/0117086 A1
(43) Pub. Date: Apr. 20, 2023

(54) Face mask in a cup shape with sticky micro droplets sprayed between its synthetic mesh layers

(71) Applicant: Rex Carroll, St. Matthews, SC (US)

(72) Inventor: Rex Carroll, St. Matthews, SC (US)

(21) Appl. No.: 17/505,407

(22) Filed: Oct. 19, 2021

(51) Int. Cl. A62B 23/02; A41D 13/11; A62B 18/10

(52) U.S. Cl. CPC A62B 23/025; A41D 13/1138; A62B 18/10; A62B 18/084

(57) ABSTRACT

A face mask that uses a super sticky substance that is sprayed between the 3 material layers of the mask and in its exhaust valve filter to trap and hold particles or microbes when breathing in and out and replicates the body's own sinus defenses in filtering air via cilia hairs and sticky mucus.

### BACKGROUND OF THE INVENTION

Face masks/coverings. Dust, particle, nuisance, virus is all personal protective face coverings filtering what a person inhales and exhales. Electrostatic cloth, copper infused and carbon infused masks.

### BRIEF SUMMARY OF THE INVENTION

1. Invention is a facial mask made of mesh filter material pressed and formed into what is known as a cup or cone style dust or particle mask. 3 individual masks are put together after being sprayed with a sticky solution forming 2 micro droplet sticky barriers, not solid, embedded in between the 3 mask layers. Sprayed on both sides of the center mask and on the concave side of the outer mask and the convex side inner mask. A plastic exhaust valve with a sticky mesh filter inside is also or can be affixed to the mask. An aluminum strip is used for a nose piece clamp. Various strapping can be used to secure invention to the head.

2. The objective of the invention is to add an extra layer of protection, not affected by the porosity of the mesh mask material, from the tiniest viruses and other microbes by grabbing and holding them in an effective yet comfortable facial mask protecting on both the inhalation side and exhalation side of breathing. This makes for an equal or better option to electrostatic material in pandemics when supplies are limited or in common care facility settings daily or situations where extra protection is needed.

### BRIEF DESCRIPTION OF THE OF THE DRAWINGS

FIG. 1A side view cross section of 3 mesh fiber filter material press formed cone style facial masks with sprayed on sticky micro droplet barrier layers in between them, plus a sticky mesh medium density fiber filter in the exhaust valve body with a headband strap and nose clamp.

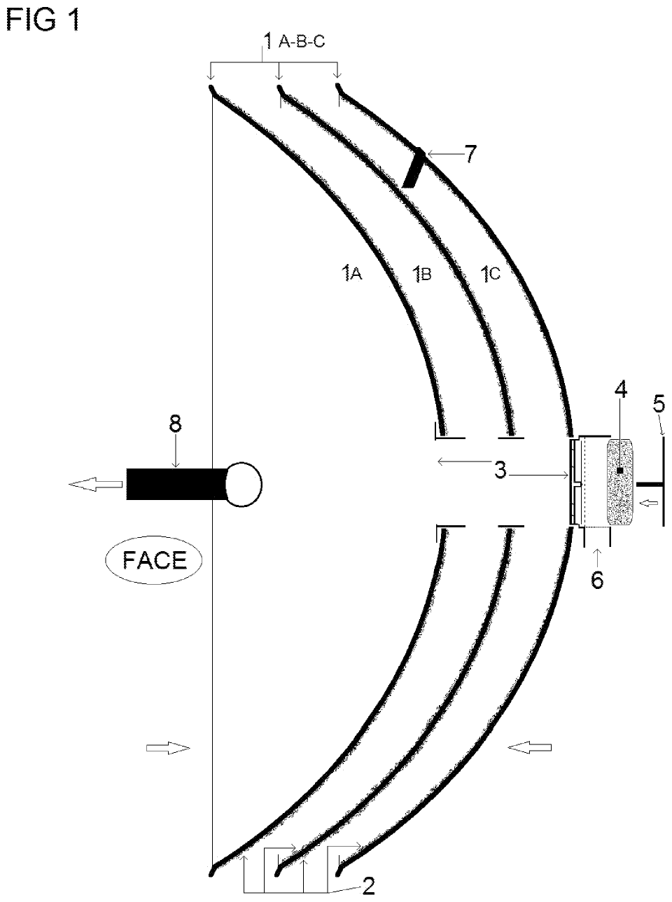

FIG. 2A side view of the mask showing the downward exhaust valve, nose clamp and strap.

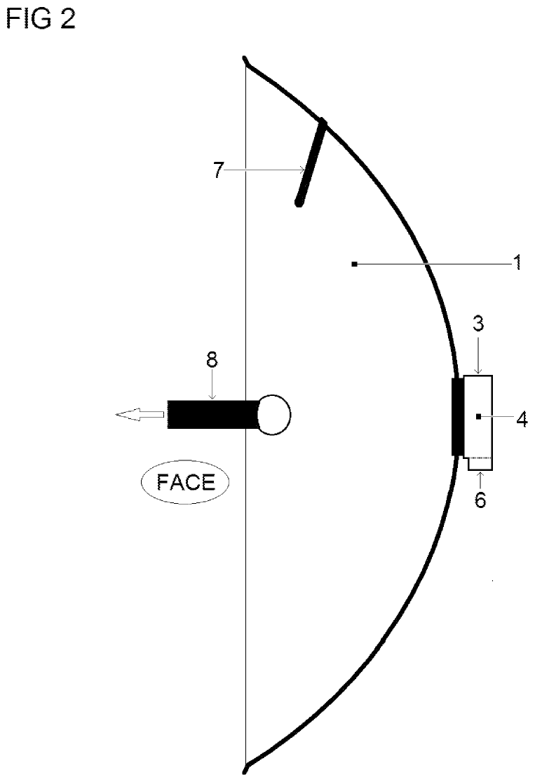

FIG. 3A front view of the facial mask showing the exhaust valve, nose clamp and head strap.

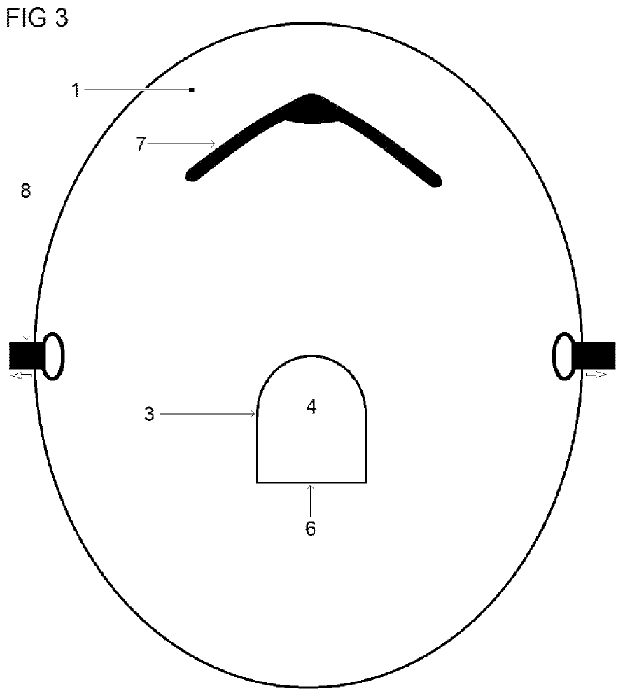

FIG. 4A rear view of the facial mask showing the inside of the mask, exhaust valve and strap.

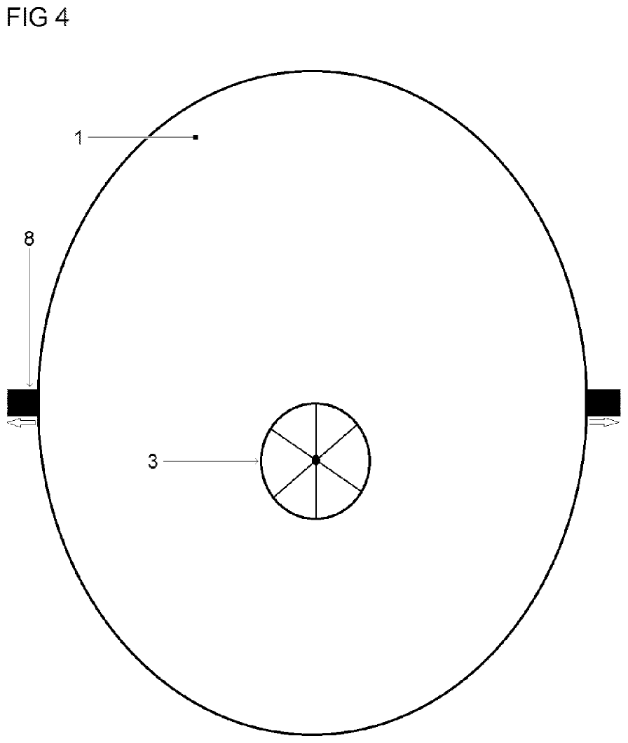

### DETAILED DESCRIPTION OF THE INVENTION

1. The invention consists of using sticky micro droplet barrier layers (2) to specifically trap and hold viruses or other harmful microbes and particles of microscopic size in a facial mask upon inhalation and exhalation as to slow the spread of viruses by keeping the wearer from breathing them in and exhaling them out. It can help keep infected persons from exhaling viruses keeping them stuck in the mask to later dispose of. The sticky sprayed on micro droplet barrier layers (2) between masks (1A,1B,1C) shown in the drawings work in concert with the mesh fiber filter mask material (1) when drawing a breath in. The valve and its filter (3) is for exhalation of breath. The aluminum nose clamp (7) and strapping securing the mask to the wearers face (8) makes for a good seal to the facial structures and skin. The nose area most importantly.

2. The invention uses this shape and material that's been available for decades but not layered with sticky barriers between them. The invention uses known valves but none have sticky mesh fiber filters embedded in the air stream channel. The shape of the mask is used because of its sealing ability to the face and skin. It also has the largest and most evenly spaced open cavity area around the nostrils and mouth area. Some facial mask styles lay on most of the face and lips affecting comfort. Some other facial masks just interrupt air flow in and out but most escapes non filtered. Some other facial masks are made of non-filtering specific material such as clothing weaves that have little porosity and block most air causing the wearer to suck the mask in. The invention does not have to depend on the porosity of the mask material to catch and hold the tiniest particles or microbes.

3. The invention is manufactured by starting with a roll of synthetic mesh material generally about 1/16 inch thick and flat. It's heated and formed onto rows of cup style masks. They are trimmed. A blank mask, 1C, is sprayed with a sticky solution on its convex or outer side from the face, the air spray pressure causes micro droplets to form. This sticky material is natural tree sap compounds in solution, fragrances can be added at this time as their terpenes are somewhat time released in the sticky sap, mainly for comfort or if in a smelly environment. The solvents then evaporate leaving micro droplets adhered to and embedded into the mesh fiber filter material surface making a ‘fogged on’ barrier layer (1,2). Then, another blank mask, (1B), is sprayed on both sides, concave and convex, then set in mask (1C) making it the center mask filter. Then a third blank mask, (1A), is sprayed on its convex side away from the face making it the inner most mask, then it is set in mask (1B) and (1C) making a 3 mask sandwich with 2 sticky barrier layers (2) between them. An ⅛ inch of reveal between the mask edges can be glued or heat crimped. This makes for a firm mask good for pulling to the face as to seal the mask and keeping an open space or cavity around nostrils and mouth. This also makes the invention mask stiffer and less likely to collapse. Breathing in creates strong vacuum so the tiniest of microbes can ride the turbulent air stream through filters bumping their way through. The sticky barrier layers can trap and hold them if touched and prevents further travel in or out of the invention.

4. The valve (3) and the valves sticky medium open density mesh fiber filter (4) is the path of least resistance for the breath exhaled so as to not leak around the mask perimeter through pressure build up inside mask. By projecting the exhaust breath air stream downward (6) and away from projecting forward this protects others. A hole is stamp cut for the plastic valve insert (3). The invention can be made and used with no valve. The plastic injected molded body of the inner valve with a silicone valve flap (3) is inserted from the inner concave face side of the now triple layered mask and the valve cap (5,6) with the sticky medium open mesh filter inside (4) is snapped to it, projecting the exhaust port downward (6), from the outside convex side of the now triple layered mask. Positioning of the valve (3) is important to be directly in front of the mouth.

5. Air flow resistance ratios between the mask material and valve filter are very important. The seal onto the face is especially important around the nose area which affects effectiveness. Facial hair makes a difference as well. Masks like this and similar are made to breathe easy even if they are half clogged by dust so stacking 2 or 3 masks increases the resistance to inhale by a factor of 3, still easy breathing. The sprayed and embedded sticky micro droplet barrier layers (2) add little if any resistance, if it was a solid sprayed layer no air would pass through the mask.

6. An aluminum nose piece clamp (7) of straight V design, ‘M’, or dual bar is then glued onto the outer mask (1C). Single or double strapping made of rubber band or elastic material, a stretchy lanyard or ear loops are (8) used to hold the facial mask snug to the wearer and are glued on. The mask can be regular size and a kid/small size. The sticky barrier practice can be used on other air filters such as a home air unit.

### DRAWINGS

1—3 formed cup facial masks A, B, C of synthetic mesh fiber filter material with 2 barrier layers of sticky micro droplets sprayed in on between them.

2—Sprayed barrier layer(s) of sticky micro droplets on and embedded in the material surface.

3—A round plastic exhaust valve insert and silicone valve flap.

4—A round sticky medium density fiber filter mesh material as the exhaust valves filter.

5—An exhaust valve cap/cover.

6—A downward projecting exhaust port from valve.

7—An aluminum nose forming clamp.

8—A rubber or elastic band strap to secure the mask to the face.

The claimed invention is:

1. a single cup style face mask that comprises 3 pre-formed blank masks of synthetic mesh material that are sprayed with sticky substances as micro droplets on their inner surfaces that are not exposed, stacked and perimeter sealed, with a breath exhaust valve that uses the sticky concept in its filter so by having sticky micro droplets between this type of mask shape and it's material layers plus the exhaust filter being sticky as well it's unique by trapping and holding particles or microbes when breathing in or out despite the masks synthetic material porosity that allows air to pass.
